(19) United States
(12) Patent Application Publication
(10) Pub. No.: US 2024/0184712 A1
(43) Pub. Date: Jun. 6, 2024

(54) MEMORY SYSTEM WITH IMPROVED MAP TABLE UPDATE EFFICIENCY, MEMORY CONTROLLER THEREFOR, AND OPERATING METHOD THEREOF

(71) Applicant: SK hynix Inc., Gyeonggi-do (KR)

(72) Inventor: Eun Soo JANG, Gyeonggi-do (KR)

(21) Appl. No.: 18/308,683

(22) Filed: Apr. 28, 2023

(30) Foreign Application Priority Data
Dec. 2, 2022 (KR) 10-2022-0166641

(51) Int. Cl. G06F 12/1009

(52) U.S. Cl. CPC G06F 12/1009

(57) ABSTRACT

A memory system may include a storage device, an external interface circuit configured to receive a write logical address associated with a write command and a storage location for mapping information and store the write logical address in the storage location; and a processor configured to determine the storage location at which the write logical address is to be stored within a map table and control the storage device to program write data associated with the write command, the map table storing map data between external logical addresses and physical addresses of the storage device.

### CROSS-REFERENCES TO RELATED APPLICATION

The present application claims priority under 35 U.S.C. § 119(e) to Korean Patent Application Number 10-2022-0166641, filed on Dec. 2, 2022, which is incorporated herein by reference in its entirety.

### BACKGROUND

### 1. Technical Field

Various embodiments of the present disclosure relate to a semiconductor integrated device, and more particularly, to a memory system with improved map table update efficiency, a memory controller therefor, and an operating method thereof.

### 2. Related Art

A memory system performs a data input and output operation according to a request received from an external device by using a volatile or nonvolatile memory device as a storage medium.

Flash memory devices are used as a major storage medium. The demands for the flash memory devices continue to increase due to advantages, such as the support of high capacity and the provision of nonvolatility, a low price, small power consumption, and a high data processing speed.

Since a logical address that is used by the external device and a physical address that is used by the storage medium are different from each other, a mapping relation between the logical address and the physical address may be managed as map data. A read or write request received from the external device may be processed with reference to the map data.

The map data is updated according to a write request. The time for processing the write request may include the time taken to update the map data in addition to the time taken to program data in the storage medium.

### SUMMARY

A memory system according to an embodiment of the present disclosure may include: a storage device; an external interface circuit configured to receive a write logical address associated with a write command and a storage location for mapping information and store the write logical address in the storage location; and a processor configured to determine the storage location at which the write logical address is to be stored within a map table and control the storage device to program write data associated with the write command, the map table storing map data between external logical addresses and physical addresses of the storage device.

A memory controller according to an embodiment of the present disclosure may include: a shared memory region; an external interface circuit configured to store, in the shared memory region, a write logical address associated with a write command, receive a storage location for mapping information from the shared memory region, and store the write logical address in the storage location; and a processor configured to determine the storage location at which the write logical address is to be stored within a map table storing map data between external logical addresses and physical addresses of a storage device, store the write logical address in the shared memory region, and control the storage device to program write data associated with the write command.

An operating method of a memory system according to an embodiment of the present disclosure may include: receiving, by an external interface circuit, a write logical address associated with a write command; receiving, by the external interface circuit, a storage location for mapping information associated with the write logical address and storing the write logical address in the storage location; and programming, by a processor, write data associated with the write command in a storage device.

An operating method of a memory system according to an embodiment of the present disclosure may include: receiving, by an external interface circuit, a write command including a write logical address and an address length; receiving, by the external interface circuit, write data associated with the write command; and programming, by a processor, the write data associated with the write command in a storage device, wherein a map table storing map data between external logical addresses and physical addresses of the storage device is updated, by the external interface circuit, before the programming of the write data has been completed by the processor.

### BRIEF DESCRIPTION OF THE DRAWINGS

FIG. 1 is a diagram illustrating a memory system according to an embodiment of the present disclosure.

FIG. 2 is a conceptual view for describing shared memory according to an embodiment of the present disclosure.

FIG. 3 is a conceptual view for describing a map table according to an embodiment of the present disclosure.

FIG. 4 is a sequence chart for describing an operating method of the memory system according to an embodiment of the present disclosure.

FIG. 5 is a flowchart for describing an operating method of the memory system according to an embodiment of the present disclosure.

### DETAILED DESCRIPTION

Hereinafter, embodiments of the present disclosure will be described in more detail with reference to the accompanying drawings. Throughout the disclosure, like reference numerals refer to like parts throughout the various figures and embodiments of the present invention. It is noted that reference to “an embodiment,” “another embodiment” or the like does not necessarily mean only one embodiment, and different references to any such phrase are not necessarily to the same embodiment(s). It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items. As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

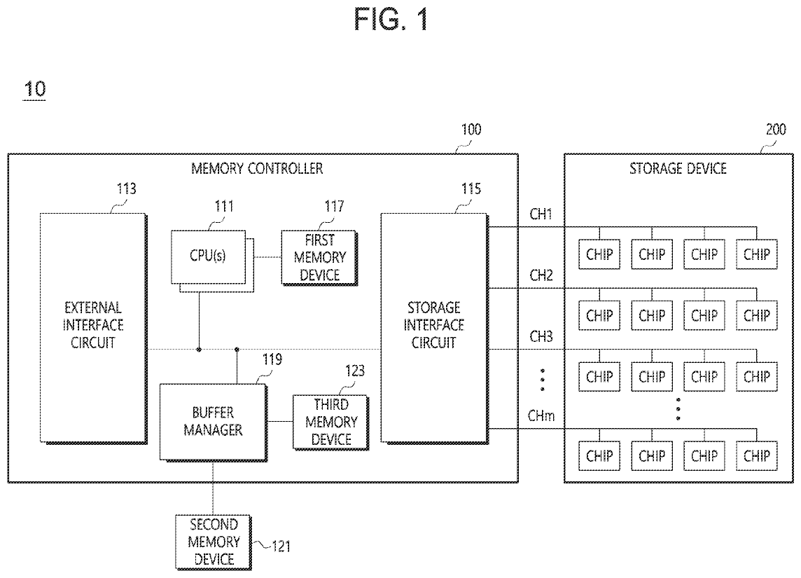

FIG. 1 is a diagram of a memory system 10 according to an embodiment of the present disclosure.

Referring to FIG. 1, the memory system 10 may include a memory controller 100 and a storage device 200. The memory system 10 may be electrically connected to an external device (not illustrated), and may transmit/receive data with the external device.

The external device (i.e., a host) may be selected from various types of computing systems, such as a personal computer, a laptop computer, a server computer, a workstation, a tablet PC, a drone, an advanced driver assistance system (ADAS), a smart TV, a smart phone, a medical device, an image display device, a measuring device, and an Internet of Things (IOT) device.

The storage device 200 may include at least one of a volatile memory device and a nonvolatile memory device. The storage device 200 may be connected to the memory controller 100 through a plurality of channels CH1, CH2, CH3, . . . , CHm, and may include a plurality of memory chips (CHIPs) or a plurality of packages. The storage device 200 may include a plurality of memory dies. Each of the dies may include one or more planes. Each of the planes may include one or more memory blocks. Each of the memory blocks may consist of a plurality of pages. A physical address may be allocated to each of memory regions that construct the storage device 200, for example, pages, blocks, planes, or dies.

The memory controller 100 may control the storage device 200 according to a request from the external device. For example, the memory controller 100 may control data to be programmed in the storage device 200, according to a write request from the external device. Furthermore, data that has been recorded on the storage device 200 may be provided to the external device according to a read request from the external device.

The memory controller 100 may include at least one processor (e.g., CPU) 111, an external interface circuit 113, a storage interface circuit 115, a first memory device 117, and a buffer manager 119. The processor 111 may have a form in which hardware and

firmware or software operating on the hardware have been combined so that the processor 111 can operate as the firmware or software that is provided for various operations of the memory system 10 is executed on the hardware. In an embodiment, the processor 111 may perform a function of a flash transport layer (FTL) for managing the storage device 200, for example, garbage collection, address mapping, or wear labeling.

The external interface circuit 113 may serve as a communication channel for receiving a command (or a request) and a clock signal from the external device and for inputting/outputting data, under the control of the processor 111. The external interface circuit 113 may provide a physical connection between the external device and the memory system 10.

In an embodiment, the external interface circuit 113 may communicate with the external device based on an interface that uses at least one of various interface protocols or standards, such as a universal serial bus (USB) protocol, a multimedia card (MMC) protocol, a peripheral component interconnection (PCI) protocol, a PCI-express (PCI-e or PCIe) protocol, an advanced technology attachment (ATA) protocol, a serial-ATA (SATA) protocol, a parallel-ATA (PATA) protocol, a small computer small interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The storage interface circuit 115 may serve as a communication channel for the transmission and reception of signals between the memory controller 100 and the storage device 200. The storage interface circuit 115 may write, in the storage device 200, data temporarily stored in a buffer memory, under the control of the processor 111. Furthermore, the storage interface circuit 115 may transfer, to the buffer memory, data read from the storage device 200 so that the buffer memory temporarily stores the data. At least one of a second memory device 121 and a third memory device 123 may serve as the buffer memory.

The first memory device 117 may store data that is to be used for an operation of the memory controller 100 or data that is generated by the memory controller 100.

The buffer manager 119 may be configured to manage the state in which the buffer memory is used. For example, the buffer manager 119 may split the buffer memory into a plurality of regions (or slots), and may allocate or release each region in order to temporarily store data.

The memory controller 100 may include at least one of the second memory device 121 and the third memory device 123. The second memory device 121 may be disposed outside the memory controller 100, and may be controlled through the buffer manager 119. The third memory device 123 may be disposed within the memory controller 100, and may be controlled through the buffer manager 119.

Map data may be generated according to a write request received from the external device and may be stored in at least one of the first memory device 117, the second memory device 121, and the third memory device 123 in the form of a map table. The map data may be kept in the storage device 20 when a predetermined condition is satisfied.

In an embodiment, the external interface circuit 113 may receive, from the external device, a write command WT CMD including a write logical address LA and a (address) length LGTH and may store the write logical address at a storage location which is received from the processor 111. The storage location may indicate a location of the map table storing information for mapping the write logical address LA to a physical address PA. The physical address PA may be an address indicative of a location of the storage device 200 at which write data is to be stored. That is, in this embodiment, the map table is updated in the external interface circuit 113, which means that the processor 111 does not update the map table when receiving the write logical address LA that is included in the write command WT CMD received from the external device.

The external device may transmit the write data subsequently to the write command WT CMD. The external interface circuit 113 may start a map table update operation when the write command WT CMD is received. The external interface circuit 113 may start the map table update operation prior to receiving the write data. Accordingly, the write speed can be improved because the interval in which the map table update operation is performed and the interval in which the write data is programmed in the storage device 200 may partially overlap.

The external interface circuit 113 and the processor 111 may use shared memory for the map table update operation. The shared memory may be allocated to some region of at least one of the first memory device 117, the second memory device 121, and the third memory device 123.

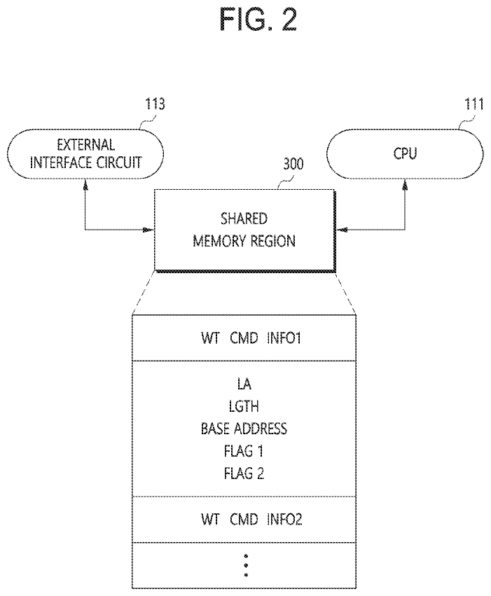

FIG. 2 is a conceptual view for describing the shared memory according to an embodiment of the present disclosure.

A shared memory region 300 may be a specific region of physical memory shared by a plurality of processes.

When the write command WT CMD including the logical address LA and the length LGTH is received from the external device, a storage region for write command information WT CMD INFO1, which is included in the shared memory region 300, may be allocated to the external interface circuit 113, under the control of the processor 111. The external interface circuit 113 may store the logical address LA and the length LGTH in the allocated storage region. Subsequently, the processor 111 may identify a location at which the logical address LA is to be stored (i.e., a storage location BASE ADDRESS within the map table) and may store the logical address LA in the shared memory region 300.

The external interface circuit 113 may obtain the storage location BASE ADDRESS from the shared memory region 300, and may perform a map table update operation of storing the logical address LA in a corresponding location. After the map table update operation is completed, the external interface circuit 113 may set a first flag FLAG1.

When the write data received from the external device is programmed in the storage device 200 through the buffer memory, the processor 111 may set a second flag FLAG2. The program operation may be performed in parallel with the map table update operation.

The write command information WT CMD INFO1, WT CMD INFO2, . . . that correspond to respective write commands WT CMD and are stored in the shared memory region 300 may be removed depending on a set condition or access authority thereto may be released.

When a read command is received from the external device, the processor 111 may process a read operation based on states of the first flag FLAG1 and the second flag FLAG2 if a read logical address included in the read command is present in the shared memory region 300.

For example, in a case where the read logical address is present in the shared memory region 300, if the first flag FLAG1 has been set and the second flag FLAG2 has not been set (i.e., a program operation for the storage device 200 has not been completed after a map table update operation), the processor 111 may read, from the buffer memory, data for which a read request has been made. If both the first flag FLAG1 and the second flag FLAG2 have been set (i.e., the map table update operation and the program operation for the storage device 200 have been completed), the processor 111 may read, from the storage device 200, the data for which a read request has been made. When the read logical address is present in the shared memory region 300 and the first flag FLAG1 has not been set, the map table update operation may have not been completed or a read command may have been transmitted while write data is received. The processor 111 may return, to the external device, garbage data or data based on the map table data that has not been updated.

In a case where the read logical address is not present in the shared memory region 300, the processor 111 may search the map table for the read logical address. When the read logical address is present in the map table, the processor 111 may read, from the storage device 200, the data for which a read request has been made. When the read logical address is not present in the map table, the processor 111 may return garbage data to the external device.

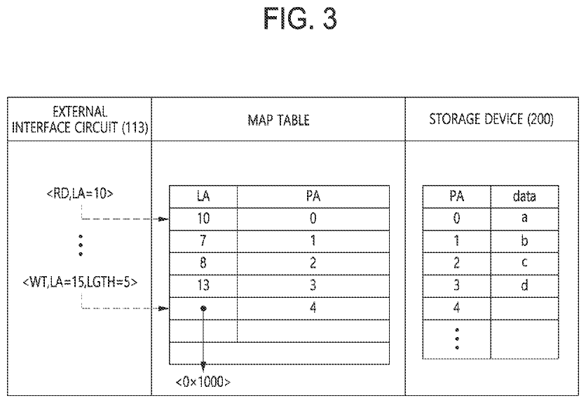

FIG. 3 is a conceptual view for describing a map table according to an embodiment of the present disclosure.

Referring to FIG. 3, the map table may store map data, that is, a mapping relation between a logical address LA and a physical address PA. The map table may be stored in at least one of the first memory device 117, the second memory device 121, and the third memory device 123.

Each of the physical addresses (PA: 0, 1, 2, 3, 4, . . . ) may be assigned to each of the storage regions of the storage device 200. Data (data: a, b, c, d) may be programmed in the storage regions, respectively, according to a write request from the external device.

The external interface circuit 113 may receive a read command (<RD, LA=10>) from the external device, and may transmit the read command to the processor 111. The processor 111 may obtain, from the map table, the physical address (PA=0) corresponding to the logical address (LA=10) that has been included in the read command (<RD, LA=10>). Furthermore, the processor 111 may read the data (data=a) from the storage region (PA=0) of the storage device 200.

The external interface circuit 113 may receive a write command (<WT, LA=15, LGTH=5>) from the external device. The external interface circuit 113 may extract the logical address LA=15 and the length LGTH=5 from the write command (<WT, LA=15, LGTH=5>), and may store the logical address LA=15 and the length LGTH=5 in the shared memory region 300. The processor 111 may store, in the shared memory region 300, a storage location BASE ADDRESS=<0x1000> within the map table on which the logical address L=15 is to be recorded.

The external interface circuit 113 may obtain the storage location BASE ADDRESS=<0x1000> from the shared memory region 300, may store the logical address LA=15 in a corresponding location, and may perform a map table update operation. When the map table update operation is completed, the external interface circuit 113 may set the first flag FLAG1. When the program operation of write data is completed, the processor 111 may set the second flag FLAG2.

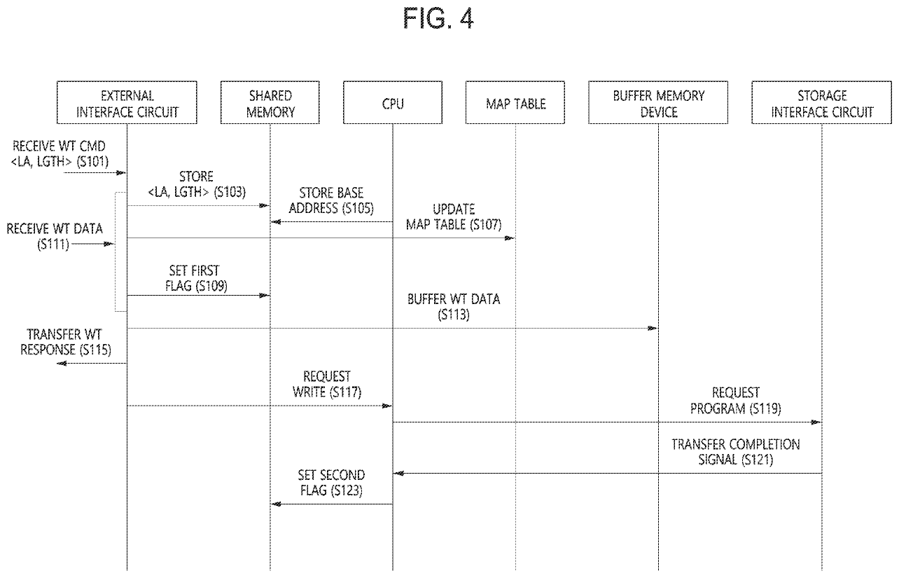

FIG. 4 is a sequence chart for describing an operating method of the memory system according to an embodiment of the present disclosure.

When receiving the write command WT CMD including the logical address LA and the length LGTH, from the external device (operation S101), the external interface circuit 113 may be assigned with a storage region for the write command information WT CMD INFO, which is included in the shared memory region 300, and may store the logical address LA and the length LGTH in the storage region (operation S103). Subsequently, the processor 111 may identify the storage location BASE ADDRESS in which the logical address LA is to be stored, and may store the logical address LA in the shared memory region 300 (operation S105).

The external interface circuit 113 may obtain the storage location BASE ADDRESS from the shared memory region 300, and may perform a map table update operation of storing the logical address LA in a corresponding location (operation S107). After the map table update operation is completed, the external interface circuit 113 may set the first flag FLAG1 (operation S109). The first flag FLAG1 may indicate whether the map table update operation corresponding to a write request has been completed.

After receiving the write command, the external interface circuit 113 may receive write data WT DATA from the external device (operation S111) while the map table update operation is performed (operations S103 to S109), and may buffer the write data WT DATA in the buffer memory (operation S113). That is, the interval in which the map table update operation is performed and the interval in which the write data WT DATA is buffered may partially overlap.

When receiving all of the write data WT DATA, the external interface circuit 113 may transmit, to the external device, a response signal for the write command (operation S115), and may request the processor 111 to process a write operation (operation S117).

The processor 111 may request the storage interface circuit 115 to process a program operation (operation S119). According to the request, the write data may be programmed in the storage device 200. When the program operation is completed, the storage interface circuit 115 may transmit a program completion signal to the processor 111 (operation S121). The processor 111 may access the shared memory region 300 and set the second flag FLAG2 (operation S123).

A write speed can be improved because the external interface circuit 113 performs a map table update operation as soon as the write command WT CMD is received and write data is buffered while the map table update operation is performed.

The external interface circuit 113 that receives a logical address to be written directly performs a map table update operation. Accordingly, map table update efficiency can be improved because a logical address should not be transmitted to the processor 111 to request the map table update operation.

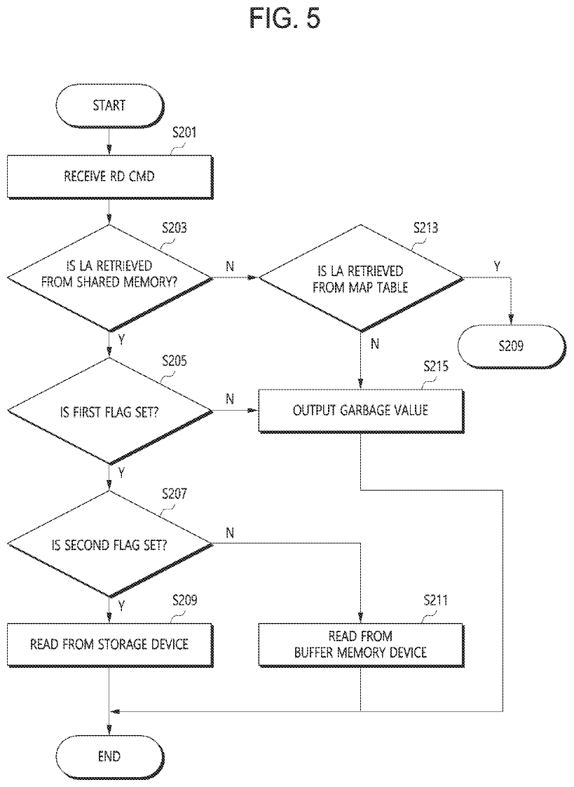

FIG. 5 is a flowchart for describing an operating method of the memory system according to an embodiment of the present disclosure.

When receiving a read command RD CMD from the external device (operation S201), the processor 111 may search (or retrieve) the shared memory region 300 for a logical address LA that is included in the read command RD CMD (operation S203).

When the logical address LA to be read is retrieved from the shared memory region 300 (‘Y’ in operation S203), the processor 111 may process a read operation based on states of the first flag FLAG1 and the second flag FLAG2.

For example, if the first flag FLAG1 has been set (‘Y’ in operation S205), the processor 111 may check whether the second flag FLAG2 has been set (operation S207). If the second flag FLAG2 has been set (‘Y’ in operation S207), the processor 111 may read, from the storage device 200, data for which a read request has been made because a map table update operation and a program operation for the storage device 200 have been completed (operation S209). If the second flag FLAG2 has not been set (‘N’ in operation S207), the processor 111 may read, from the buffer memory, data for which a read request has been made because a program operation for the storage device 200 has not been completed after a map table update operation is completed (operation S211).

When the read logical address is not present in the shared memory region 300 (‘N’ in operation S203), the processor 111 may search the map table for the read logical address (operation S213). When the read logical address is present in the map table (‘Y’ in operation S213), the processor 111 may read, from the storage device 200, data for which a read request has been made (operation S209). When the read logical address is not present in the map table (‘N’ in operation S213), the processor 111 may return garbage data to the external device (operation S215).

Furthermore, if the first flag FLAG1 has not been set (‘N’ in operation S205), the map table update operation may have not been completed or the read command may have been transmitted while write data is received. Accordingly, the processor 111 may return, to the external device, garbage data or data based on map data that has not been updated (operation S215).

A read command for a logical address that is present in the shared memory region can be efficiently processed because the external interface circuit 113 updates map data by using a shared memory method.

According to embodiments of the present disclosure, a write request processing time can be reduced because a map data update operation and a write data program operation can be performed in parallel.

As described above, those skilled in the art to which the present disclosure pertains may understand that the present disclosure may be implemented in various other forms without departing from the technical spirit or essential characteristics of the present disclosure. Accordingly, it is to be understood that the aforementioned embodiments are illustrative from all aspects not being limitative. The scope of the present disclosure is defined by the appended claims rather than by the detailed description, and all modifications or variations derived from the meanings and scope of the claims and equivalents thereof should be understood as being included in the scope of the present disclosure and the following claims. Furthermore, the embodiments may be combined to form additional embodiments.

What is claimed is:

1. A memory system comprising:
a storage device;
an external interface circuit configured to receive a write logical address associated with a write command and a storage location for mapping information and store the write logical address in the storage location; and
a processor configured to determine the storage location at which the write logical address is to be stored within a map table and control the storage device to program write data associated with the write command, the map table storing map data between external logical addresses and physical addresses of the storage device.

2. The memory system according to claim 1, wherein the external interface circuit is configured to start receiving the write data after the write logical address is stored in the storage location.

3. The memory system according to claim 1, wherein an interval in which the write logical address is stored in the storage location and an interval in which the write data is input are configured to partially overlap.

4. The memory system according to claim 1, wherein the external interface circuit is configured to set a first flag indicating whether the storage of the write logical address has been completed.

5. The memory system according to claim 1, wherein the processor is configured to set a second flag indicating whether the programming has been completed.

6. The memory system according to claim 1, wherein:
the external interface circuit is configured to set a first flag indicating whether the storage of the write logical address has been completed,
the processor is configured to set a second flag indicating whether the programming has been completed, and
the processor is configured to process a read command based on the first flag and the second flag set for a read logical address associated with the read command.

7. A memory controller comprising:
a shared memory region;
an external interface circuit configured to store, in the shared memory region, a write logical address associated with a write command, receive a storage location for mapping information from the shared memory region, and store the write logical address in the storage location; and
a processor configured to determine the storage location at which the write logical address is to be stored within a map table storing map data between external logical addresses and physical addresses of a storage device, store the write logical address in the shared memory region, and control the storage device to program write data associated with the write command.

8. The memory controller according to claim 7, wherein the external interface circuit is configured to start receiving the write data after the write logical address is stored in the storage location.

9. The memory controller according to claim 7, wherein an interval in which the write logical address is stored in the storage location and an interval in which the write data is input are configured to partially overlap.

10. The memory controller according to claim 7, wherein the external interface circuit is configured to store, in the shared memory region, a first flag indicating whether the storage of the write logical address has been completed.

11. The memory controller according to claim 7, wherein the processor is configured to store, in the shared memory region, a second flag indicating whether the programming has been completed.

12. The memory controller according to claim 7, wherein the processor is configured to process a read command based on a first flag and a second flag for a read logical address associated with the read command, the first flag indicating whether the storage of the write logical address has been completed, and the second flag indicating whether the programming has been completed.

13. An operating method of a memory system, the operating method comprising:
receiving, by an external interface circuit, a write logical address associated with a write command;
receiving, by the external interface circuit, a storage location for mapping information associated with the write logical address and storing the write logical address in the storage location; and
programming, by a processor, write data associated with the write command in a storage device.

14. The operating method according to claim 13, further comprising starting to receive the write data after the write logical address is stored in the storage location.

15. The operating method according to claim 13, wherein an interval in which the write logical address is stored in the storage location and an interval in which the write data is input are configured to partially overlap.

16. The operating method according to claim 13, wherein the receiving of the write logical address comprises:
receiving, by the external interface circuit, the write command including the write logical address and an address length, from an external device; and
storing, by the external interface circuit, the write logical address and the address length in the shared memory region.

17. The operating method according to claim 13, wherein the receiving of the storage location comprises:
determining, by the processor, the storage location at which the write logical address is to be stored within a map table storing map data between external logical addresses and physical addresses of the storage device;
storing, by the processor, the write logical address in the shared memory region; and
reading, by the processor, the storage location from the shared memory region.

18. The operating method according to claim 13, further comprising setting, by the external interface circuit, a first flag after completing the storage of the write logical address.

19. The operating method according to claim 13, further comprising setting, by the processor, a second flag after completing a program operation of the write data.

20. The operating method according to claim 13, further comprising:
setting, by the external interface circuit, a first flag after completing the storage of the write logical address;
setting, by the external interface circuit, a second flag after completing a program operation of the write data;
receiving a read command from an external device; and
processing a read command based on the first flag and the second flag set for a read logical address associated with the read command.

21. An operating method of a memory system, the operating method comprising:
receiving, by an external interface circuit, a write command including a write logical address and an address length;
receiving, by the external interface circuit, write data associated with the write command; and
programming, by a processor, the write data associated with the write command in a storage device,
wherein a map table storing map data between external logical addresses and physical addresses of the storage device is updated, by the external interface circuit, before the programming of the write data has been completed by the processor.
